(19) United States
(12) Patent Application Publication
(10) Pub. No.: US 2007/0062016 A1
(43) Pub. Date: Mar. 22, 2007

(54) Lower electrode dressing tool for projection welding

(76) Inventors: Kevin Veenstra, (US); Jack Gray, (US); Steve Rudd, (US)

Correspondence Address: BRADLEY ARANT ROSE & WHITE LLP, 200 CLINTON AVE. WEST, SUITE 900, HUNTSVILLE, AL, 35801, US

(21) Appl. No.: 11/231,157

(22) Filed: Sep. 20, 2005

(51) Int. Cl. B23P 19/00

(52) U.S. Cl. 29/33 K; 29/56.5

(57) ABSTRACT

A lower electrode dressing tool for projection welding machine is disclosed. The dresser includes a rotating cutting mechanism that includes multiple cutting elements. The rotating cutting mechanism has an opening and locating pin in the interior of the mechanism that seats and stabilizes a lower electrode of a projection welding machine against the dresser. While the dresser is in motion, the multiple cutting elements ride against and dress the flat upper surface of the lower electrode.

### BACKGROUND OF THE INVENTION

1. Field of the Invention

The invention relates generally to welders. More specifically, the present invention relates to an improved dresser for a welding electrode.

2. Background Art

Projection welding is a variation of traditional spot welding. Projections are designed in a designated part of the workpieces to be welded together. These projections act as current concentrators for electrodes on the welding machines.

When the two workpieces are mated together, these projections are the high points that first make contact. As the power is cycled, the projections simultaneously carry the current and are welded. The force and current that is applied from the welding machine is concentrated in a small contact area.

The process is well established and is applicable mainly to low carbon or micro-alloyed steels. The process is widely used on sheet metal assemblies in automotive and white goods industries for both sheet joining and attaching nuts and studs. Steel wire shopping carts, wire mesh, wire racks, and other crosswire products are all projection welding. Nuts and bolts are often welded to other metal parts by projection welding.

The advantages of projection welding include its versatility, the speed and ability to automate, the ability to make a number of welds simultaneously and minimization of marking on one side of joints in sheet materials. The weld is typically completed in a single shot within milliseconds. FIG. 1 shows a perspective view of a projection welder 10 with an electrode 18. The welder 10 includes a frame 12 that supports the workpieces being fed through the welder 10. The welding is done by an upper element 14 and a lower element 16 with an electrode 18 that come together to apply force and current to make the weld. FIG. 2 shows a cross-sectional view of a projection weld formed when the electrode 18 is pressed against the workpiece 22.

During the welding process, the electrodes eventually become inoperable due to deformation from the heat and pressure. The electrodes has to be replaced and refurbished for further use. This requires that production activities involving the welding machine while the electrode is replaced or refurbished. It would be advantageous to refurbish the electrode with a dresser that minimizes the interruption to production involving the welding machine.

### SUMMARY OF INVENTION

In some aspects, the invention relates to a dresser for refurbishing a welding electrode, comprising: a rotating cutting mechanism that comprises a plurality of cutting elements; an opening within the interior of the cutting mechanism that seats the welding electrode against the cutting elements; and a locating pin within the opening that contacts against the welding electrode to stabilize the rotating cutting mechanism.

In other aspects, the invention relates to a dresser for refurbishing a welding electrode, comprising: a rotating cutting mechanism that comprises a plurality of cutting elements; means for seating the welding electrode against the cutting elements; and means for stabilizing the rotating cutting mechanism against the welding electrode with a locating pin.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 shows a perspective view of a projection welder with an electrode.

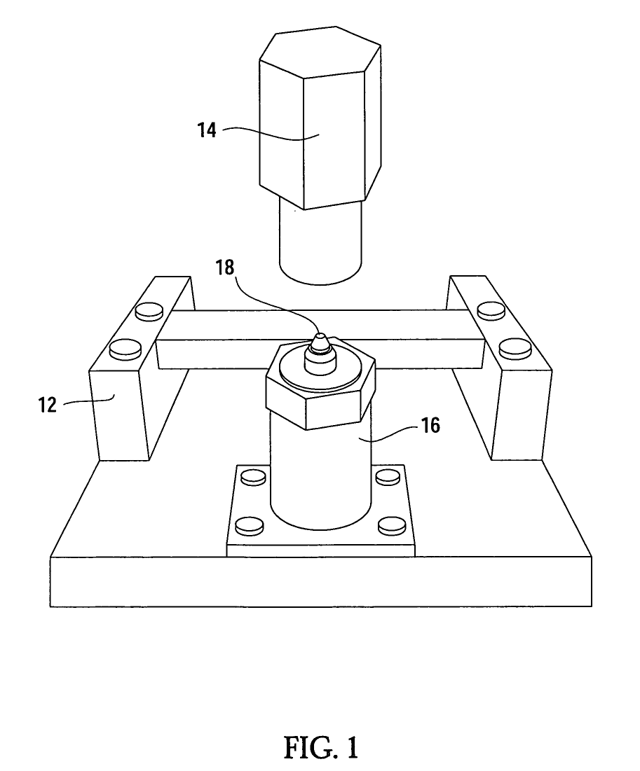

FIG. 2 shows a cross-sectional view of a projection weld.

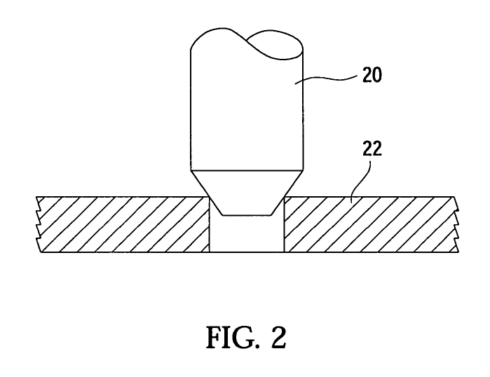

FIG. 3 shows a perspective view of an electrode dresser in accordance with one embodiment of the present invention.

FIG. 4 shows an exploded perspective view of an electrode dresser in accordance with one embodiment of the present invention.

FIGS. 5a and 5b show exploded frontal and side views respectively of an electrode dresser in accordance with one embodiment of the present invention.

FIG. 6 shows a perspective view of a cutting adapter for an electrode dresser in accordance with one embodiment of the present invention.

FIGS. 7a and 7b show cross-sectional overhead and side views respectively of a cutting adapter for an electrode dresser in accordance with one embodiment of the present invention.

### DETAILED DESCRIPTION

A lower electrode dressing tool for projection welding machine is disclosed. The present invention includes a rotary dresser that refurbishes a welding electrode. The dresser has a locating pin that stabilizes the dresser as its rotating cutting elements reshape and resurface the electrode. This allows for smoother and more accurate performance of the dresser

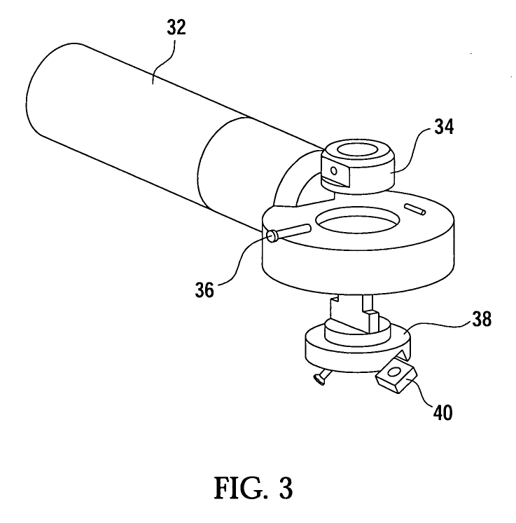

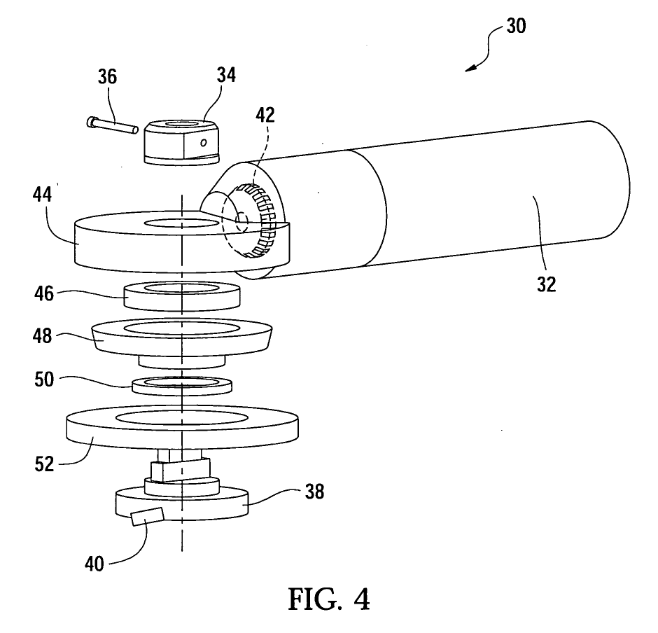

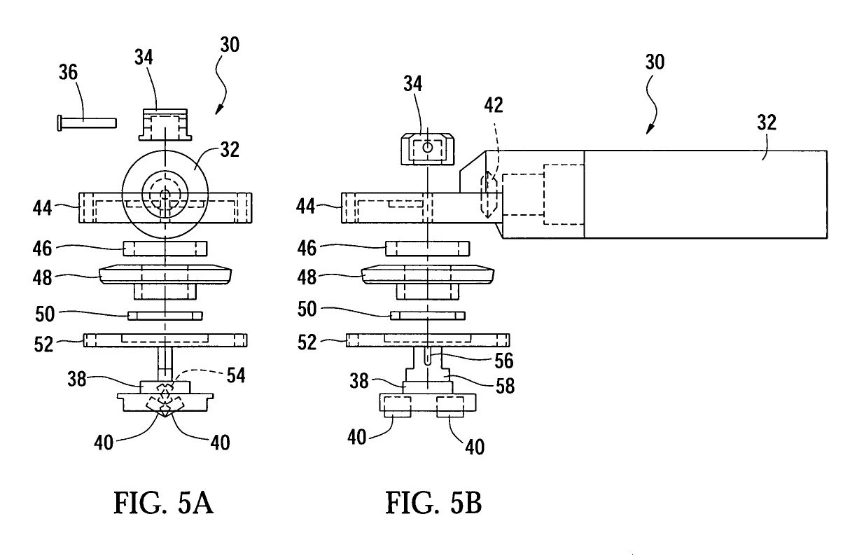

FIG. 3 shows a perspective view of an electrode dresser 30 in accordance with one embodiment of the present invention. The dresser 30 includes an air motor 32 that powers the device. A cutting adapter 38 that contains cutting elements 40 is mounted to the dresser 30 with a retaining cap 34 and retaining pin 36. FIGS. 4, 5a and 5b show exploded perspective, front and side views respectively this embodiment of the electrode dresser 30. The interior of the dresser 30 includes a bevel pinion 42 that transfers power to the bevel gear 48 inside the gear head housing 44. The bevel gear 48 along with a roller bearing 46 and a thrust bearing 50 are held in place with a retaining cap.

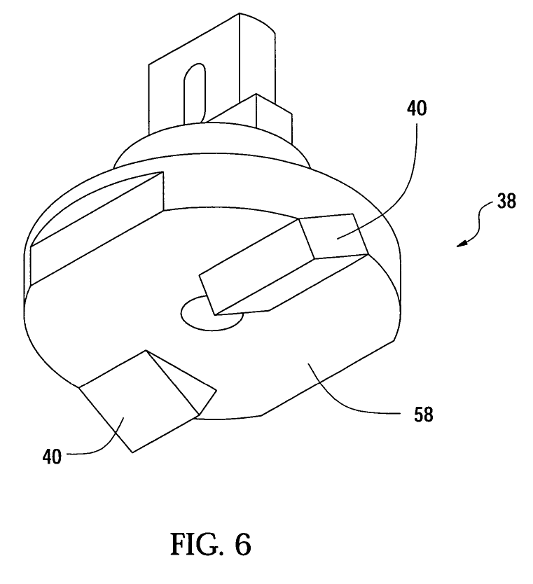

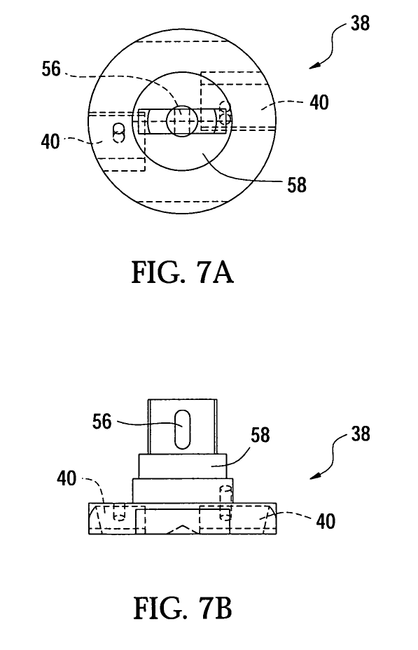

In the present embodiment, FIGS. 5a, 5b, 6, 7a, and 7b show the cutting adapter 38 that has two separate cutting elements 40. In alternative embodiments, additional cutting elements could be added to the adapter. As shown in FIGS. 5a; the cutting elements have an orientation angle 54 of 120° with respect to each other. In other embodiments, different angles could be used. FIGS. 5b, 7a, and 7b show a locating pin 56 that is located internally within the cutting adapter 38.

The advantage of the present invention is seen in FIG. 5b and 7b which shows the locating pin 56 inside a hollow opening 58 within the interior of the cutting adapter 38. When the dresser 30 is cutting, the electrode will seat within the opening and the locating pin 56 will press against the top of the electrode. In some embodiments, the lower electrode will have a centering hole on its top. The centering hole will be a receptacle that receives and seats the locating pin from the dresser. This will stabilize the dresser 30 as it rotates and cuts into the surface of the electrode. This provides a quicker and more efficient refurbishing of the electrode.

While certain examples of the present invention have been described in detail, it should be clear that other embodiment s are possible. For example, the dresser is described as being powered by a pneumatic air motor. However, other types of motors such as electric, hydraulic, etc. could be used. Additionally, the dresser itself could be a tool that is used manually by an individual or it could be an automated part of the welder. Such an automated dresser would be used to automatically refurbish the electrode when the welding machine halts production.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. A dresser for refurbishing a welding electrode, comprising:
a rotating cutting mechanism that comprises a plurality of cutting elements;
an opening within the interior of the cutting mechanism that seats the welding electrode against the cutting elements; and
a locating pin within the opening that contacts against the welding electrode to stabilize the rotating cutting mechanism.

2. The dresser of claim 1, where the dresser is power by a pneumatic motor.

3. The dresser of claim 1, where the dresser is a manual tool.

4. The dresser of claim 1, where the dresser is a component of a projection welding machine.

5. The dresser of claim 4, where the welding electrode comprises a locating hole that seats the locating pin of the dresser.

6. The dresser of claim 1, where the rotating cutting mechanism comprises two cutting elements.

7. The dresser of claim 6, where the two cutting elements are oriented at an angle of 120° with respect to each other.

8. A dresser for refurbishing a welding electrode, comprising:
a rotating cutting mechanism that comprises a plurality of cutting elements;
means for seating the welding electrode against the cutting elements; and
means for stabilizing the rotating cutting mechanism against the welding electrode with a locating pin.

9. The dresser of claim 8, further comprising:
means for seating the locating pin against the welding electrode with a locating hole in the welding electrode.
